(19) United States
(12) Patent Application Publication
(10) Pub. No.: US 2021/0370111 A1
(43) Pub. Date: Dec. 2, 2021

(54) AIRCRAFT ZONAL FIRE SUPPRESSION SYSTEMS AND METHODS

(71) Applicant: The Boeing Company, Chicago, IL (US)

(72) Inventors: Derek Tyler Diaz, Everett, WA (US); Douglas E. Ferguson, Cypress, CA (US); Patrick Thomas Baker, Everett, WA (US); George A. McEachen, Mukilteo, WA (US)

(73) Assignee: The Boeing Company, Chicago, IL (US)

(21) Appl. No.: 16/890,963

(22) Filed: Jun. 2, 2020

(51) Int. Cl. A62C 3/08; A62C 37/38; A62C 35/13; A62C 35/02; A62C 35/68

(52) U.S. Cl. CPC A62C 3/08; A62C 37/38; A62C 35/13; B64D 2045/009; A62C 35/026; A62C 35/68; A62C 35/023

(57) ABSTRACT

Described herein are zonal fire suppression systems and methods of using such systems for suppressing fires in cargo aircraft. A system is configured to individually monitor the temperature in each of multiple cargo zones in the cargo area. The system is also configured to selectively activate one or more of multiple zone distribution components to distribute a fire suppressant material, based at least on the temperature monitoring. The zonal approach to the temperature monitoring and to the fire suppressant material distribution allows reducing the fire suppressant material amount needed on the cargo aircraft, which, in turn, reduces the aircraft load. Furthermore, in some examples, the zonal approach eliminates unnecessary contact between the cargo (e.g., in the zones unaffected by fire) and the fire suppressant material. In some examples, this fire suppression involves depressurizing of the cargo area, in addition to or instead of the fire suppressant material distribution material.

### BACKGROUND

Cargo aircraft, which are sometimes referred to as freighters, are specifically configured to transport bulk cargo. Fire risks and/or fire suppression requirements and options for cargo aircraft can be different from passenger aircraft. For example, cargo itself may be a source of fire and/or fuel for fire. Furthermore, various fire suppression techniques suitable for cargo aircraft may not be suitable for passenger aircraft due to various risks to passengers. Also, ground-based fire suppression systems are generally not applicable to any aircraft because of large weight penalties.

Most of the conventional fire suppression systems used on aircraft still rely on halogenated hydrocarbons (e.g., Halon) as fire extinguishing agents. However, halogenated hydrocarbons have been identified as a major cause of ozone depletion and have been gradually banned in the US and throughout the world. This ban leaves few fire suppressant material options suitable for aircraft applications and specifically for cargo aircraft applications. In addition, some conventional systems are heavy, requiring large amounts of fire suppressant material, as these systems are intended for use in large cargo compartments and designed to spread fire suppressant material within the entire cargo area. Furthermore, conventional systems are usually limited to depressurizing cargo aircraft in response to the main deck fire. This may be effective at reducing the fire intensity or preventing the fire spread at high elevations (e.g., 5,000 to 8,000 meters), where the oxygen partial pressure/concentration is low. However, upon descent to lower altitudes, the depressurization may not be as effective and the fire intensity could increase due to the increase in the oxygen partial pressure/concentration.

### SUMMARY

Described herein are zonal fire suppression systems and methods of using such systems for suppressing fires in aircraft, such cargo aircrafts. A zonal fire suppression system is configured to individually monitor the temperature in each of multiple cargo zones in the cargo area. The system is also configured to selectively activate one or more of multiple zone distribution components to distribute a fire suppressant material, based at least on the temperature monitoring and the flight altitude. The zonal approach to the temperature monitoring and to the fire suppressant material distribution allows reducing the fire suppressant material amount needed on the cargo aircraft, which, in turn, reduces the aircraft load. Furthermore, in some examples, the zonal approach eliminates unnecessary contact between the cargo (e.g., in the zones unaffected by fire) and the fire suppressant material. In some examples, this fire suppression involves depressurizing of the cargo area, in addition to or instead of the fire suppressant material distribution.

In some examples, a zonal fire suppression system for use in a cargo area of a cargo aircraft for hauling cargo is provided. The zonal fire suppression system comprises a thermal monitoring sub-system, configured to extend across multiple cargo zones of the cargo area and to individually monitor temperature in each of the multiple cargo zones. The zonal fire suppression system further comprises a fire suppressant material distribution sub-system, comprising multiple zone distribution components for positioning across the multiple cargo zones of the cargo area such that each of the multiple cargo zones corresponds to a different arrangement of the multiple zone distribution components. The zonal fire suppression system comprises a fire suppression controller, configured to receive the temperature, measured in each of the multiple cargo zones by the thermal monitoring sub-system and a flight altitude of the cargo aircraft and to perform at least one of (a) selectively activating of at least one of the multiple zone distribution components of the fire suppressant material distribution sub-system to selectively release a fire suppressant material within one or more of the multiple cargo zones based on at least one of the temperature in each of the multiple cargo zones or the flight altitude of the cargo aircraft, or (b) depressurizing the cargo aircraft based on at least one of the temperature in each of the multiple cargo zones or the flight altitude of the cargo aircraft.

Also provided is a method for suppressing fire in a cargo area of a cargo aircraft using a zonal fire suppression system. In some examples, the method comprises monitoring temperature in each of multiple cargo zones of the cargo area using a thermal monitoring sub-system of the zonal fire suppression system. The method further comprises analyzing the temperature in each of the multiple cargo zones using fire suppression controller of the zonal fire suppression system and monitoring a flight altitude of the cargo aircraft. Furthermore, based on the temperature in at least one of the multiple cargo zones and the flight altitude of the cargo aircraft, the method proceed with performing at least one of (a) selectively activating of at least one of multiple zone distribution components of a fire suppressant material distribution sub-system to selectively release a fire suppressant material within one or more of the multiple cargo zones based on at least one of the temperature in each of the multiple cargo zones or the flight altitude of the cargo aircraft or (b) depressurizing the cargo aircraft based on at least one of the temperature in each of the multiple cargo zones or the flight altitude of the cargo aircraft.

In some examples, a zonal fire suppression system, for use in a cargo area of a cargo aircraft for hauling cargo, comprises a thermal monitoring sub-system, configured to extend across multiple cargo zones of the cargo area and to individually monitor temperature in each of the multiple cargo zones. The zonal fire suppression system also comprises a fire suppressant material distribution sub-system, comprising multiple zone distribution components for positioning across the multiple cargo zones of the cargo area such that each of the multiple cargo zones corresponds to a different arrangement of the multiple zone distribution components. Each of the multiple zone distribution components comprises a zone conduit and one or more distributors. The one or more distributors are fluidically coupled to the zone conduit. The zone conduit of one of the multiple zone distribution components is configured to overlap with the zone conduit of an adjacent one of the multiple zone distribution components. The zonal fire suppression system also comprises a fire suppression controller, configured to receive the temperature, measured in each of the multiple cargo zones by the thermal monitoring sub-system and, optionally, a flight altitude of the cargo aircraft and to perform at least one of (a) selectively activating of at least one of the multiple zone distribution components of the fire suppressant material distribution sub-system to selectively release a fire suppressant material within one or more of the multiple cargo zones based on at least one of the temperature in each of the multiple cargo zones or the flight altitude of the cargo aircraft or (b) depressurizing the cargo aircraft based on at least one of the temperature in each of the multiple cargo zones or the flight altitude of the cargo aircraft.

### BRIEF DESCRIPTION OF THE DRAWINGS

FIG. 1 is a schematic illustration of a cargo aircraft, equipped with a zonal fire suppression system, in accordance with some examples.

FIGS. 2A and 2B are side schematic views of two examples of a zonal fire suppression system.

FIG. 3 is a top schematic view of a zonal fire suppression system, in accordance with some examples.

FIG. 4 is a block diagram, illustrating various connections and information exchange between systems and components of a cargo aircraft, including a zonal fire suppression system, in accordance with some examples.

FIG. 5 is a block diagram, illustrating different inputs and outputs of the fire suppression controller, in accordance with some examples.

FIG. 6 is a process flowchart corresponding to a method for suppressing fire in a cargo area of a cargo aircraft using a zonal fire suppression system, in accordance with some examples.

FIG. 7 is a process flowchart corresponding to a method for manufacturing and servicing the aircraft.

FIG. 8 illustrates a block diagram of an example aircraft, in accordance with some examples.

### DETAILED DESCRIPTION

In the following description, numerous specific details are set forth in order to provide a thorough understanding of the presented concepts. In some examples, the presented concepts are practiced without some or all of these specific details. In other instances, well known process operations have not been described in detail so as to not unnecessarily obscure the described concepts. While some concepts will be described in conjunction with the specific examples, it will be understood that these examples are not intended to be limiting.

### Introduction

Fire suppression systems for cargo aircraft have specific requirements and opportunities, which may be different from passenger aircraft systems and especially different from ground-based systems, such as building fire suppression systems. For example, the cargo itself may be a source of fire and/or a source of fuel, once the fire has started. Some cargo may be a source of oxidants. At the same time, since there are no passengers onboard cargo-only aircraft, different fire suppression techniques may be carried out. For example, intentional depressurization (e.g., for fire suppression due to lack of oxygen at high altitudes) of cargo aircraft is permitted. In a similar manner, using fire suppressant material in a cargo area may be less risky or damaging than in a passenger compartment. Furthermore, cargo aircraft require fewer facilities and systems (e.g., lavatories, galley kitchens, and the like) and corresponding supplies (e.g., water, food). As a result, some of these weight and space savings may be utilized on cargo aircraft for fire suppression systems.

Finally, it should be noted that ground-based fire suppression systems are generally not applicable to any aircraft due to severe weight restrictions for any systems on the aircraft. For example, many ground-based fire suppression systems rely on a virtually unlimited source of water or other similar types of fire suppressant materials. While water is easily available in buildings, the amount of water that an aircraft can carry during any flight is quite limited. Furthermore, flight durations before aircraft can safely land and evacuate can be measured by many hours (e.g., an aircraft flying over an ocean). Any fire event should be sufficiently mitigated while in flight and for the remainder of the flight. On the other hand, a flying aircraft can take advantage of the reduced oxygen concentration at high altitudes. For example, a cargo aircraft can be depressurized to reduce the amount of oxygen in the area and, potentially, reduce the temperature in the cargo area.

Described herein are zonal fire suppression systems for cargo aircrafts and methods of using such systems for suppressing fires in cargo areas of cargo aircrafts. A zonal fire suppression system is configured to individually monitor temperature in each of multiple cargo zones in the aircraft cargo area. This feature allows to pin-point a fire event to a specific cargo zone and focus fire suppression activities to this zone, thereby preserving the fire suppressant material amount available on the aircraft. Specifically, the zonal fire suppression system is configured to selectively activate one or more of multiple zone distribution components to distribute a fire suppressant material. Instead of distributing the fire suppressant material in the entire cargo area, the distribution is limited to one or more zones associated with a fire event and, in some examples, adjacent zones. Distributing the fire suppressant material in adjacent zones is used to seal off the fire from the rest of the cargo area and prevent spreading of the fire. Besides reducing the fire suppressant material amount needed on board of the cargo aircraft, the zonal approach allows avoiding unnecessary contact between the cargo and the fire suppressant material. Furthermore, in some examples, this fire suppression involves depressurizing of the cargo aircraft, e.g., in addition to the fire suppressant material distribution. For example, at high altitudes with low oxygen contact, depressurizing of the cargo area may be sufficient to suppress the fire without a need to distribute the fire suppressant material or reducing the amount of the fire suppressant material needed onboard of the cargo aircraft, which in turn increases the payload capacity of the aircraft.

It should be noted that zonal fire suppression is applicable to fire suppressant materials, which are not gas-based. Gas-based fire suppressant materials are hard to restrict to a particular zone, e.g., in an open cargo area. Furthermore, fire suppressant materials provide more cooling effect than gas-based fire suppressant materials, which is of particular benefit for thermal control during fire events, e.g., preventing various critical components of the aircraft from overheating.

### Examples of Cargo Aircraft and Zonal Fire Suppression Systems for These Aircraft

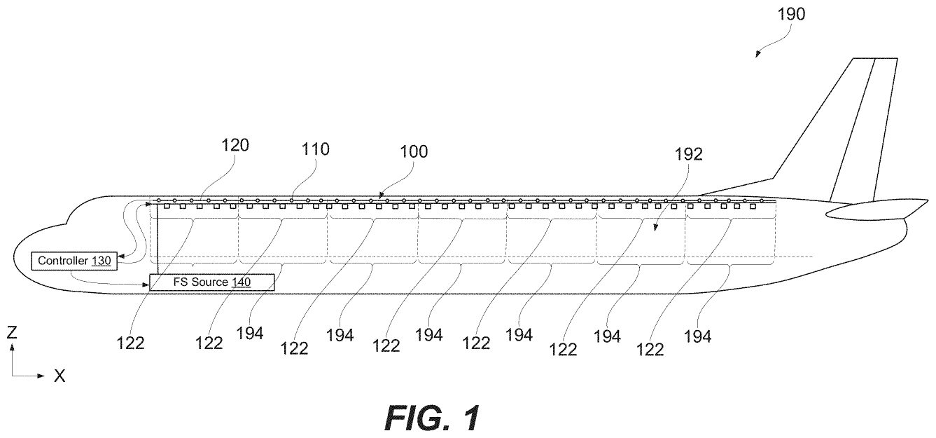

FIG. 1 is a schematic illustration of cargo aircraft 190, equipped with zonal fire suppression system 100, in accordance with some examples. Zonal fire suppression system 100 is positioned in cargo area 192 of aircraft 190. Cargo area 192 comprises multiple cargo zones 194, representing different parts of cargo area 192. The number and position of cargo zones 194 may depend on the size of cargo aircraft 190 and other factors. While FIG. 1 illustrates cargo zones 194 forming a linear array along the X-axis, one having ordinary skill in the art would understand that cargo zones 194 can be arranged in various other ways (e.g., two-dimensional arrays, stacked along the Z-axis, and the like). In some examples, the size of each cargo zone is between 1 meter and 15 meters or, more specifically, between 3 meters and 10 meters. For example, a pallet, used on cargo aircraft has a footprint of 3.175 meters by 3.175 meters. Other aircraft cargo containers may be larger in size. In some examples, cargo area 192 is isolated from a pilot cabin, which allows distributing the fire suppressant material in cargo area 192 without interfering with operations in the pilot cabin.

Zonal fire suppression system 100 is configured to individually monitor the temperature in each of multiple cargo zones 194 and, in some examples, to selectively distribute a fire suppressant material in one or more of multiple cargo zones 194. For example, zonal fire suppression system 100 is configured to selectively distribute a fire suppressant material and potentially depressurize cargo aircraft 190 based on identifying a fire event in at least one of multiple cargo zones 194. Various ways and factors used for identifying a fire event are presented below. Furthermore, in some examples, zonal fire suppression system 100 is configured to employ other fire suppression techniques, such as depressurization of cargo aircraft 190 and shutting off the airflow to cargo area 192. Combining multiple different fire suppression techniques allows reducing the reliance on any given one and, for example, reducing the amount of the fire suppressant material needed on cargo aircraft 190 and/or more efficient and faster fire suppression.

Referring to FIG. 1, zonal fire suppression system 100 comprises thermal monitoring sub-system 110, fire suppressant material distribution sub-system 120, and fire suppression controller 130. These components of zonal fire suppression system 100 are installed on cargo aircraft 190 during fabrication, retrofitting, and/or maintenance of cargo aircraft 190. In some examples, one or more of these components are integrated into other components or systems of cargo aircraft 190. For example, fire suppression controller 130 may be a part of a larger control system of cargo aircraft 190.

Thermal monitoring sub-system 110 is configured to extend across multiple cargo zones 194 of cargo area 192 and to individually monitor the temperature in each of multiple cargo zones 194. For example, thermal monitoring sub-system 110 comprises multiple thermocouples such that each of multiple cargo zones 194 has one or more of these thermocouples when zonal fire suppression system 100 is installed on cargo aircraft 190. In some examples, thermal monitoring sub-system 110 is a continuous fiber-optic temperature sensor, which is configured to independently measure temperatures at multiple points along the length of thermal monitoring sub-system 110. Other examples of thermal monitoring sub-system 110 are also within the scope. In some examples, thermal monitoring sub-system 110 has multiple and redundant sensors and multiple controller channels to prevent false alarms.

Temperature monitoring based on various temperature-related thresholds (e.g., exceeding a certain temperature threshold, a temperature difference relative to an adjacent cargo zone, temperature increasing faster than a certain rate) is used to identify a fire event in one or more cargo zones 194. In some examples, the results of the temperature monitoring (provided by thermal monitoring sub-system 110) are combined with other inputs, such as smoke detection, gas analysis, and the like.

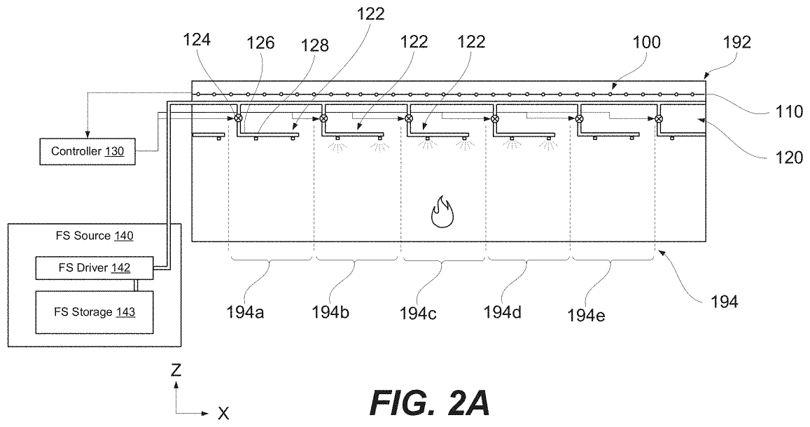

Referring to FIG. 1, fire suppressant material distribution sub-system 120 comprises multiple zone distribution components 122. When zonal fire suppression system 100 is installed in cargo aircraft 190, multiple zone distribution components 122 are positioned across multiple cargo zones 194 of cargo area 192. More specifically, each of multiple cargo zones 194 corresponds to a different arrangement of multiple zone distribution components 122. These arrangements are described below with references to FIGS. 2A and 2B.

Referring to FIG. 1, fire suppression controller 130 is configured to receive the temperature, measured in each of multiple cargo zones 194. As noted above, the temperature is measured at multiple points in cargo area 192 by thermal monitoring sub-system 110, which transmits the measurements to fire suppression controller 130. Fire suppression controller 130 is also configured to selectively activate at least one of multiple zone distribution components 122 of fire suppressant material distribution sub-system 120, e.g., based at least in part on the temperature in each of multiple cargo zones 194. For example, the temperature in each cargo zone 194 is compared by fire suppression controller 130 to various temperature-related thresholds, as listed above. In some examples, fire suppression controller 130 uses additional input (e.g., smoke detection) to selectively activate at least one of multiple zone distribution components 122 of fire suppressant material distribution sub-system 120. Fire suppression controller 130 is also configured to depressurize cargo aircraft 190 based on the temperature in each of multiple cargo zones 194, the flight altitude of cargo aircraft 190, and, in some examples, other input. As described below, the depressurization technique is effective at high altitudes where the oxygen partial pressure/concentration is low. A combined and selective use of multiple fire suppression techniques allows increasing the payload of cargo aircraft 190 (by reducing the amount of the fire suppressant material needed onboard of cargo aircraft 190) and increasing the fire suppression efficiency across multiple flight conditions (e.g., the depressurization being less efficient at low altitudes). It should be noted that in some examples, multiple fire suppression controllers are used, e.g., performing different functions, e.g., thermal detection, smoke detection, fires suppression material discharge, depressurization.

Referring to FIG. 1 as well as FIGS. 2A and 2B, zonal fire suppression system 100 further comprises fire suppressant material source 140. During operation of zonal fire suppression system 100, fire suppressant material source 140 is at least partially filled with a fire suppressant material selected from the group consisting of water, foam, and various mixtures thereof. In some examples, the fire suppressant material is referred to as a liquid-based fire suppressant material, e.g., to distinguish from gas fire suppressant materials, such as halogenated hydrocarbons. The amount of the fire suppressant material in fire suppressant material source 140 depends on various factors, such as duration of the flight, cargo weight, cargo fire risk, aircraft weight capacity, and the like. In some examples, the amount of the fire suppressant material on cargo aircraft is between about 200 kilograms and about 3000 kilograms or, more specifically, between about 500 kilograms and about 2000 kilograms. For example, 1500 kilograms of water, used as a mist for fire suppression, provides about 30 minutes of suppression in a typical cargo space when the zonal fire suppression is used. It should be noted that excessive amounts of the fire suppressant material on board of cargo aircraft 190 cause a weight penalty, limiting the cargo weight that can be carried. Fire suppressant material source 140 is fluidically coupled to fire suppressant material distribution sub-system 120.

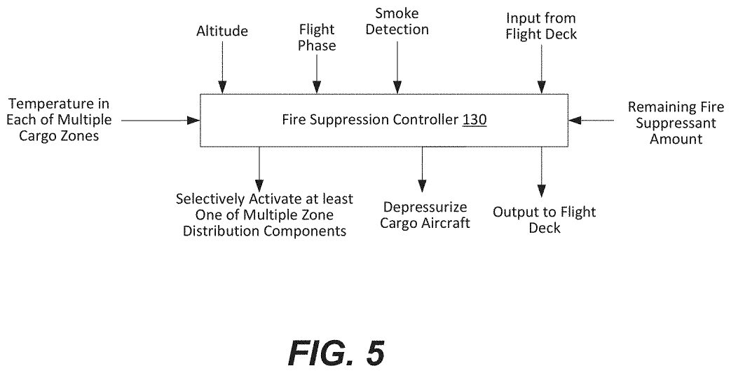

Referring to FIGS. 2A and 2B, fire suppressant material source 140 comprises fire suppressant material driver 142 (labeled as FS Driver 142) and fire suppressant material storage 143 (labeled as FS Storage 143). Fire suppressant material driver 142 is configured to move the fire suppressant material from fire suppressant material storage 143 to fire suppressant material distribution sub-system 120. Some examples of fire suppressant material driver 142 include but are not limited to a pressurized gas (e.g., nitrogen, carbon dioxide, air), a pump, and the like. In some examples, fire suppressant material driver 142 and fire suppressant material storage 143 is the same components, e.g., a pressurized agent. The pressurized gas provides motive flow for the fire suppressant material and, in some examples, assist in the atomization of the, such as water, at the discharge source(s) or distribution components. The pressurized gas has a minimal weight penalty and does not require external power sources, but has a limited operating range (e.g., needs to be recharged after each use). In some examples, the nitrogen, which is used to drive water mist represents less than 50% or even less than 40% of the total weight of fire suppressant material driver 142 and fire suppressant material storage 143. The agent would also need to be replenished after use. The operation of fire suppressant material driver 142 is controlled by fire suppression controller 130. For example, fire suppression controller 130 is configured to control and selectively activate fire suppressant material driver 142 in sync with activating at least one of multiple zone distribution components 122 of fire suppressant material distribution sub-system 120. More specifically, fire suppression controller 130 controls each individual valve 124 based on the aircraft state information, such as the phase of flight, the altitude, the cabin pressure, and the like as well as thermal monitoring controller (e.g., threat zone), flight deck (e.g., switch position for manual discharge, cargo fire arm/depressurization switch position), and fluid distribution system (e.g., source pressures, valve positions). Fire suppression controller 130 determines the sequence, duration, and other characteristics of the fire suppression as further described below with reference to FIG. 6.

The location of fire suppressant material storage 143 varies, depending on the aircraft model and the aircraft configuration. In some examples, fire suppressant material driver 142 and fire suppressant material storage 143 are positioned in the same general area of cargo aircraft 190. Some examples of suitable locations include, but are not limited to, the crown, the lower lobe cheeks, the aft of the forward or aft lower lobe cargo compartments, the a cargo compartment, and the like. In some examples, fire suppressant material storage 143 is equipped with a sensor for monitoring the remaining amount of the fire suppressant material in fire suppressant material storage 143. The output of this sensor is provided to fire suppression controller 130 and used by fire suppression controller 130 to selectively activate at least one of multiple zone distribution components 122 of fire suppressant material distribution sub-system 120.

Referring to FIGS. 2A and 2B, each of multiple zone distribution components 122 comprises valve 124, zone conduit 126, and one or more distributors 128. Valve 124 is coupled to and selectively controls the flow of the fire suppressant material to the corresponding zone conduit 126. Zone conduit 126 is configured to extend within at least a corresponding one of multiple cargo zones 194. Furthermore, one or more distributors 128 are fluidically coupled to zone conduit 126 and, in some examples, are supported by zone conduit 126. One or more distributors 128 are configured to uniformly distribute the fire suppressant material within the corresponding one of multiple cargo zones 194 when valve 124 allows the flow of the fire suppressant material into zone conduit 126. Some examples of distributors 128 include, but are not limited to, nozzles, misters, and the like.

In some examples, one or more distributors 128 are configured to generate mist in at least a corresponding one of multiple cargo zones 194. The small droplets of the fire suppressant material in the mist provide more efficient utilization of the fire suppressant material. The efficient utilization is particularly important for cargo aircraft application where the amount of the fire suppressant material is limited while the time to descend and land the aircraft may be substantial. In some examples, this efficient utilization is coupled with intermittent operation of fire suppressant material distribution sub-system 120 and/or identifying specific periods during the remaining flight when fire suppressant material distribution sub-system 120 is utilized to distribute the fire suppressant material.

In some examples, valve 124 of each of multiple zone distribution components 122 is independently controlled by fire suppression controller 130. The actuation of valve 124 may be provided by electrical or pneumatic means. For example, fire suppression controller 130 receives input from thermal monitoring sub-system 110 and, in some examples, from one or more other sensors (e.g., smoke detectors, suppressant amount sensor). Fire suppression controller 130 then identifies, based on this input, a fire event in one or more of multiple cargo zones 194. Based on this identification of the fire event, fire suppression controller 130 instructs to open valve 124 of zone distribution component 122 associated with this cargo zone. In some examples, fire suppression controller 130 also instructs to open one or more additional valves associated with adjacent cargo zones, as further described below. Furthermore, in some examples, the flow rate of the fire suppressant material is controlled (e.g., varied) based on various inputs (e.g., the temperature in one or more cargo zones, received from thermal monitoring sub-system 110). For example, fire suppression controller 130 can control the output of fire suppressant material driver 142 and/or position of each valve 124 (e.g., allowing for partially opened valves). This level of control allows preserving or, more specifically, rationing the fire suppressant material, e.g., using a lower flow rate for conditions associated with a smaller fire and/or longer remaining flight.

Referring to FIG. 2A, in some examples, each of multiple zone distribution components 122 corresponds to a specific cargo zone 194, e.g., cargo zones 194a-194e identified in FIG. 2A. This may be referred to as a 1-to-1 arrangement. For example, fire suppression controller 130 is configured to selectively activate zone distribution component 122 associated with cargo zone 194 associated with a fire event (based on at least the temperature data received by fire suppression controller 130 from thermal monitoring sub-system 110). In more specific examples, additional zone distribution components 122 are activated as well, e.g., corresponding to adjacent cargo zones 194.

FIG. 2A illustrates an example in which fire suppression controller 130 has identified a fire event in cargo zone 194c, e.g., based on the temperature input from thermal monitoring sub-system 110. Fire suppression controller 130 activates zone distribution component 122 positioned in cargo zone 194c. At the same time, fire suppression controller 130 activates zone distribution component 122 positioned in cargo zone 194b and cargo zone 194d. In this example, cargo zone 194c is positioned between cargo zone 194b and cargo zone 194d. In other words, zone distribution component 122 in cargo zone 194c is a middle one of the three adjacent zone distribution components 122, activated by fire suppression controller 130. The selective activation of zone distribution components 122 corresponding to cargo zone 194b and cargo zone 194d provides barriers for fire spreading within cargo area 192. In some examples, these multiple cargo zones (each associated with a fire event) are adjacent to each other, in which case, zone distribution components 122 corresponding to each of these cargo zones are activated in addition to zone distribution components 122 corresponding to two adjacent zones, e.g., on each end. Alternatively, when these multiple cargo zones (each associated with a fire event) are not adjacent to each other, zone distribution components 122, corresponding to these cargo zones, are activated. In some examples, additional zone distribution components 122 are activated as well, e.g., corresponding to any end zones to provide fire barrier. Furthermore, if a fire event is detected in the first or last cargo zone, which may be referred to as an end cargo zone, then fire suppression controller 130 selectively activates zone distribution component 122 only in this end cargo zone and, in some examples, an additional zone distribution component corresponding to one adjacent cargo zone.

Returning to the example in FIG. 2A, zone distribution components 122 corresponding to cargo zone 194a and cargo zone 194e remain inactive, e.g., to preserve the fire suppressant material and/or prevent potential damage to the cargo in these cargo zones from contact with the fire suppressant material. In some examples, the activation of zone distribution components 122 follows a specific sequence, e.g., to prevent the fire spreading caused by the activation itself (e.g., causing airflow within cargo area 192 when the fire suppressant material is discharged or preventing splashing when the liquid cargo in on fire). For example, zone distribution components 122 corresponding to cargo zone 194b and cargo zone 194d are activated first, followed by activation of zone distribution component 122 corresponding to cargo zone 194c.

Referring to FIG. 2B, in some examples, zone conduit 126 of one zone distribution component 122 is configured to overlap with zone conduit 126 of an adjacent zone distribution component 122. In more specific examples, zone conduit 126 of each zone distribution component 122 extends into multiple cargo zones. For example, FIG. 2B illustrates zone conduit 126, corresponding to the activated zone distribution component 122, extending through cargo zone 194b, cargo zone 194c, and cargo zone 194d. The overlapping of zone distribution components 122 provides full coverage regardless of where each of distribution components 122 is positioned within cargo area 192. The overlapping design also takes into account possible equipment failures, e.g., malfunctioning valves, etc. This overlap and multi-zone coverage allows creating various fire distribution buffers by activating, in some examples, only one zone distribution component for an identified fire event. For example, FIG. 2B illustrates a fire in cargo zone 194c. In response, fire suppression controller 130 activates zone distribution component 122 extending through cargo zone 194b, cargo zone 194c, and cargo zone 194d. Fire suppression controller 130 does not activate any adjacent zone distribution components, unlike the example described above with reference to FIG. 2A.

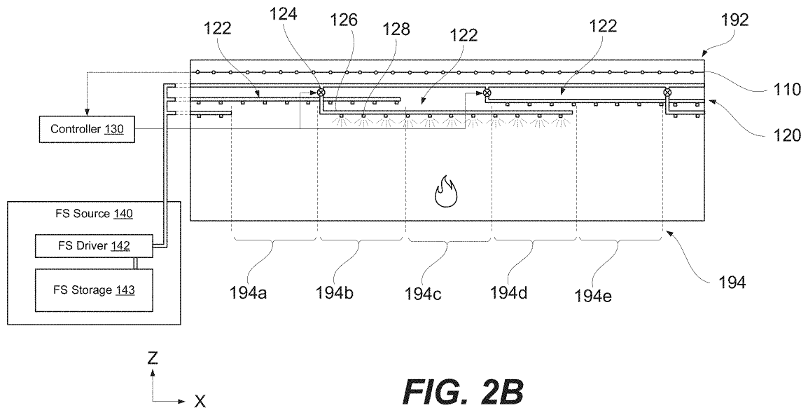

FIG. 3 is a schematic top down view of cargo area 192, illustrating one example of zone conduit 126 extending through three cargo zones (cargo zone 194a, cargo zone 194b, and cargo zone 194c). Zone conduit 126 extends to different parts of each cargo zone (in both X and Y directions identified in FIG. 3) to provide uniform distribution of the fire suppressant material within cargo area 192. FIG. 3 also illustrates the position of thermal monitoring sub-system 110 within cargo area 192. In some examples, thermal monitoring sub-system 110 is configured to sense the temperature in multiple locations within each of multiple cargo zones. The sensing locations are selected, e.g., based on the cargo position, the direction of flames (e.g., toward to the top portion of the fuselage), and other like factors. In some examples (e.g., smaller aircraft), a single center zone conduit 126 extends along the X axis of cargo area 192. In some examples, the overlapping of zonal distribution components 122 is between about 20 and about 80%, or between about 30 and about 75%, such as between about 40 and about 50% overlap with adjacent zonal distribution components 122.

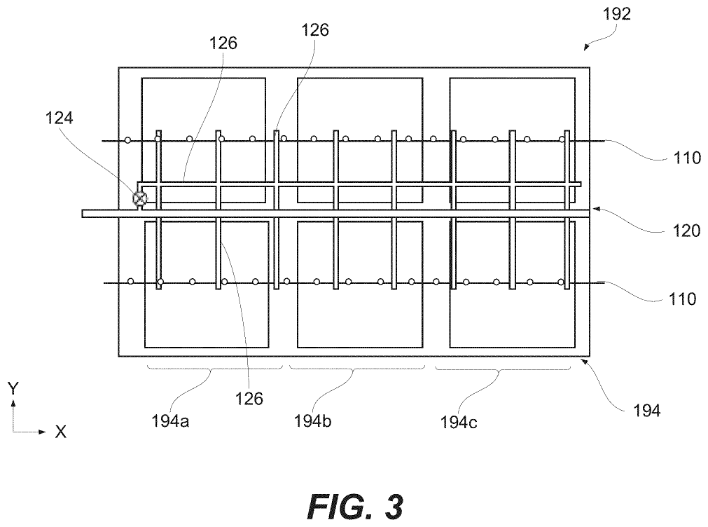

FIG. 4 is a schematic block diagram of various components of cargo aircraft 190, which interact with zonal fire suppression system 100 during operation of cargo aircraft 190. In some examples, fire suppression controller 130 is configured to communicate with flight deck 196 of cargo aircraft 190, e.g., via aircraft data buses 195. For example, when fire suppression controller 130 identifies a fire event in one or more cargo zones, fire suppression controller 130 informs flight deck 196 about this fire event. In some examples, fire suppression controller 130 is further configured to selectively activate at least one of multiple zone distribution components 122 of fire suppressant material distribution sub-system 120 based on input from flight deck 196. For example, a pilot is able to manually override fire suppression controller 130. In some examples, fire suppression controller 130 is further configured to selectively activate at least one of multiple zone distribution components 122 of fire suppressant material distribution sub-system 120 based on input from flight deck 196.

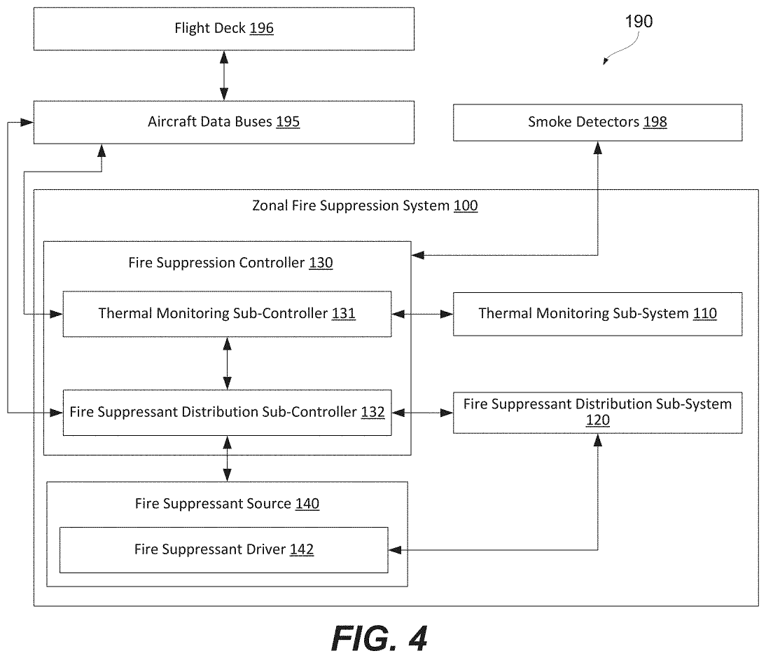

In some examples, fire suppression controller 130 receives information from other components of cargo aircraft 190, such as smoke detectors 198 and/or flight deck 196. This information may be used to determine fire events (e.g., in combination with the information received from thermal monitoring sub-system 110) and/or determine operating conditions for each multiple zone distribution components 122 (e.g., which ones of multiple zone distribution components 122 to activate, when to activate, activation duration, and the like). In some examples, fire suppression controller 130 is further configured to selectively activate at least one of multiple zone distribution components 122 of fire suppressant material distribution sub-system 120 based on at least one of a phase of flight (e.g., received from flight deck 196), an altitude of cargo aircraft 190, (e.g., flight deck 196), pressure inside cargo area 192 or amount of fire suppressant material available on cargo aircraft 190, and/or temperature in a cargo zone 194 (e.g., sensed by thermal monitoring sub-system 110). In other words, fire suppression controller 130 is configured to perform a comprehensive analysis of multiple factors to determine various operating conditions for each multiple zone distribution component 122, as listed above. Various inputs and outputs of fire suppression controller 130 are presented in FIG. 5. For example, fire suppression controller 130 is further configured to receive input from each of multiple smoke detectors 198, positioned in multiple cargo zones 194, and to selectively activate at least one of multiple zone distribution components 122 of fire suppressant material distribution sub-system 120 based on input from each of multiple smoke detectors 198.

In some examples, based on the information from fire suppression controller 130, cargo aircraft 190 is automatically or manually (e.g., via the input from flight deck 196) depressurized. Simultaneously or, in some examples, not until cargo aircraft 190 descends below approximately 6,000 meters (e.g., the altitude depending on the size and threat of the fire), fire suppression controller 130 automatically or manually (e.g., via the input from flight deck 196) activates zone distribution components 122 to operate and discharge the fire suppressant material. In some examples, the amount and timing of the fire suppression material is automatically controlled or manually controlled. The fire suppression material is used, for example, at any point after a fire is detected (e.g., either without depressurization, prior to depressurization, after depressurization, or concurrent with depressurization). In addition, the amount of the fire suppressant material is controlled based on factors such as the severity of the fire, depressurization, altitude (above or below 6,000 meters) and/or the length of time necessary for descent.

As noted above, thermal monitoring sub-system 110 supplies temperature information to fire suppression controller 130. This temperature information is specific to each cargo zone. For example, the temperature information represents multiple data collection points in each cargo zone. In some examples, fire suppression controller 130 is configured to selectively activate at least one of multiple zone distribution components 122 of fire suppressant material distribution sub-system 120 based on at least one of (a) the temperature in each of multiple cargo zones 194 exceeding a maximum temperature threshold, or (b) an increase in temperature in each of multiple cargo zones 194 exceeding a maximum rate threshold.

### Examples of Methods for Suppressing Fires on Cargo Aircraft Using Zonal Fire Suppression Systems

FIG. 6 is a process flowchart corresponding to method 600 for suppressing fire in cargo area 192 of cargo aircraft 190, in accordance with some examples. Various operations of method 600 are performed using zonal fire suppression system 100, which is described above with reference to FIGS. 1-5.

In some examples, method 600 comprises monitoring (block 610) the temperature in each cargo zone 194 of cargo area 192. This operation is performed using thermal monitoring sub-system 110 of zonal fire suppression system 100. More specifically, thermal monitoring sub-system 110 extends through each of multiple cargo zones 194. In some examples, thermal monitoring sub-system 110 monitors the temperature at multiple different locations in each cargo zone 194. Furthermore, in some examples, monitoring the temperature is performed continuously, e.g., during the entire flight of cargo aircraft 190 and even when cargo aircraft 190 is on the ground.

In some examples, method 600 further comprises monitoring (block 611) the flight altitude of cargo aircraft 190. This operation is performed, for example, by fire suppression controller 130, based on input from flight deck 196. As further described below, the flight altitude is used to determine the operating sequence and other parameters for zonal fire suppression system 100.

In some examples, method 600 further comprises receiving (block 612) input from each of multiple smoke detectors 198, positioned in cargo zones 194. This input is received by fire suppression controller 130. As further described below, multiple zone distribution components 122 are selectively activated (by fire suppression controller 130) based on input from each of multiple smoke detectors 198.

In some examples, method 600 comprises monitoring (block 615) the remaining amount of the fire suppressant material in fire suppressant material source 140 of zonal fire suppression system 100. This information is supplied to fire suppression controller 130 for analysis. For example, this amount is one of several factors considered by fire suppression controller 130 to determine operating conditions of multiple zone distribution components 122. In fact, the amount of the remaining fire suppressant material is a key factor to determine these operating conditions (e.g., neither multiple zone distribution component 122 can be operational if the fire suppressant material is not available).

In some examples, method 600 comprises analyzing (block 620) the temperature in each of multiple cargo zones 194. This operation is performed using fire suppression controller 130 of zonal fire suppression system 100. More specifically, fire suppression controller 130 analyzes the temperature information (received om thermal monitoring sub-system 110) to determine the likelihood of a fire event in one or more cargo zones 194. For example, the analysis of fire suppression controller 130 is based on temperature changes in each cargo zone, temperature differences among different cargo zones, temperatures exceeding set thresholds, and the like. These analysis factors may be collectively referred to as temperature-related thresholds. Various inputs to fire suppression controller 130 for this analysis are shown in FIG. 5 and described above. Furthermore, FIG. 5 illustrates various output of this analysis.

In some examples, analyzing (block 620) the temperature in each of multiple cargo zones 194 comprises at least one of (a) comparing temperature in each of multiple cargo zones 194 to a maximum temperature threshold or (b) comparing an increase in temperature in each of multiple cargo zones 194 to a maximum rate threshold. In some examples, the maximum temperature threshold is between about 100° C. and about 700° C. or, more specifically, between about 100° C. and about 500° C. In the same or other examples, the maximum rate threshold is between about 10° C./second and about 100° C./second or, more specifically, between about 20° C./second and about 50° C./second. More specifically, the analysis is based on both of these thresholds.

In some examples, if the temperature in at least one of multiple cargo zones 194 exceeds (block 630) one or more temperature-related thresholds, method 600 proceeds with activating (block 640) at least one of multiple zone distribution components 122. As described above, multiple zone distribution components 122 are parts of fire suppressant material distribution sub-system 120 of zonal fire suppression system 100. At least one of multiple zone distribution components 122 corresponds to each cargo zone 194. More specifically, one or more of zone distribution components 122, which are activated, correspond to the cargo zone with an identified fire event, e.g., where the temperature exceeds one or more temperature-related thresholds. In some examples, zone distribution components 122 corresponding to adjacent cargo zones are also activated to reduce the risk of spreading the fire.

In some examples, if the temperature in the at least one of multiple cargo zones 194 and/or the flight altitude of cargo aircraft 190 exceeds (block 630) one or more thresholds, method 600 proceeds with depressurizing (block 650) cargo aircraft 190 and/or selectively activating (block 640) at least one of multiple zone distribution components 122. Overall, the fire suppression is performed (a) using various combinations of activating at least one of multiple zone distribution components 122 and depressurizing cargo aircraft 190, (b) entirely by activating at least one of multiple zone distribution components 122, or (c) entirely by depressurizing cargo aircraft 190. The selection of these fire suppressions depends on the registered temperatures, the flight altitude, availability of the fire suppressant material, and/other factors as further described below. For example, at least one of multiple zone distribution components 122 is activated in addition to depressurizing cargo aircraft 190. In some examples, cargo area 192 is depressurized prior to activating at least one of multiple zone distribution components 122, e.g., to conserve the fire suppressant material.

In some examples, the depressurization of cargo aircraft 190 and the activation of zone distribution components 122 are governed by different criteria, such as different temperature-related thresholds, different phases of the flight, different altitudes, the amount of the fire suppressant material, and the like. Some of these inputs to fire suppression controller 130 are shown in FIG. 5. For example, the depressurization of cargo aircraft 190 is effective at high-altitudes where less oxygen is available. Furthermore, the depressurization of cargo aircraft 190 is executable regardless of the remaining amount of the fire suppressant material. On the other hand, the depressurization of cargo aircraft 190 may be damaging to some types of cargo (e.g., live animals) and may interfere with operation of cargo aircraft 190 (e.g., necessitates use of oxygen masks by pilots).

In some examples, at high altitudes (e.g., above 6000 meters), and wherein there are no animal cargo or live species cargo, the depressurization of cargo aircraft 190 is used as a primary/initial way of fire suppressions. Zone distribution components 122 are activated, for example, if the depressurization of cargo aircraft 190 is not effective (e.g., after using for a predetermined period of time) or when the fire event is particularly severe (e.g., fast spreading, high temperatures). On the other hand, at low altitudes (e.g., below 5000 meters), the activation of zone distribution components 122 is a primary/initial way of fire suppression since the depressurization of cargo aircraft 190 has only limited effect due to the higher oxygen concentration at lower altitudes.

In some examples, selectively activating (block 640) at least one of multiple zone distribution components 122 comprises activating only one of multiple zone distribution components 122. Referring to FIG. 2B, described above, in some examples, this activated zone distribution component extends over multiple cargo zones, e.g., three cargo zones. The middle one of these three cargo zones is associated with a fire event, as identified by fire suppression controller 130.

In some examples, activating (block 640) at least one of multiple zone distribution components 122 comprises activating three of multiple zone distribution components 122. Referring to FIG. 2A, described above, these three zone distribution components extend over at least one of multiple cargo zones 194, which has been associated with a fire event, and both adjacent ones of multiple cargo zones 194. Activating zone distribution components 122 in adjacent cargo zones 194 is used to establish a barrier for spreading the fire past the cargo zone associated with the fire event.

In some examples, activating (block 640) at least one of multiple zone distribution components 122 comprises generating fire suppressant material mist in at least one of multiple cargo zones 194. As noted above, the small droplets of the fire suppressant material in the mist provide more efficient utilization of the fire suppressant material. The efficient utilization is particularly important for cargo aircraft application where the amount of the fire suppressant material is limited while the time to descend and land the aircraft may be substantial.

In some examples, activating (block 640) at least one of multiple zone distribution components 122 is further based on at least one of a phase of flight, an altitude of cargo aircraft 190, pressure inside cargo area 192, amount of fire suppressant material available on cargo aircraft 190, or temperature in a cargo zone 194 as sensed by thermal monitoring sub-system 110. Various inputs used by fire suppression controller 130 for identifying a fire event are shown in FIG. 5. Furthermore, some inputs are used by fire suppression controller 130 to select the fire suppression techniques (e.g., activating zone distribution components 122, depressurizing cargo area 192, and the like), the order of these techniques, the starting and ending points for each technique, and the like.

In some examples, if the temperature in at least one of multiple cargo zones 194 exceeds one or more temperature-related thresholds, method 600 proceeds with providing (block 660) input to flight deck 196 of cargo aircraft 190. For example, fire suppressant material distribution sub-system 120 of zonal fire suppression system 100 is controllable from flight deck 196 of cargo aircraft 190.

In some examples, method 600 is executed continuously. In other words, monitoring (block 610) the temperature in each of multiple cargo zones 194 and analyzing (block 630) the temperature as shown by the return arrows to block 610. These monitoring and analyzing operations are performed regardless of the temperature in at least one of the multiple cargo zones 194 exceeding (decision block 630) the one or more temperature-related thresholds.

### Aircraft Examples

In some examples, methods and systems described above are used on aircraft and, more generally, by the aerospace industry. Specifically, these methods and systems can be used during fabrication of aircraft as well as during aircraft service and maintenance.

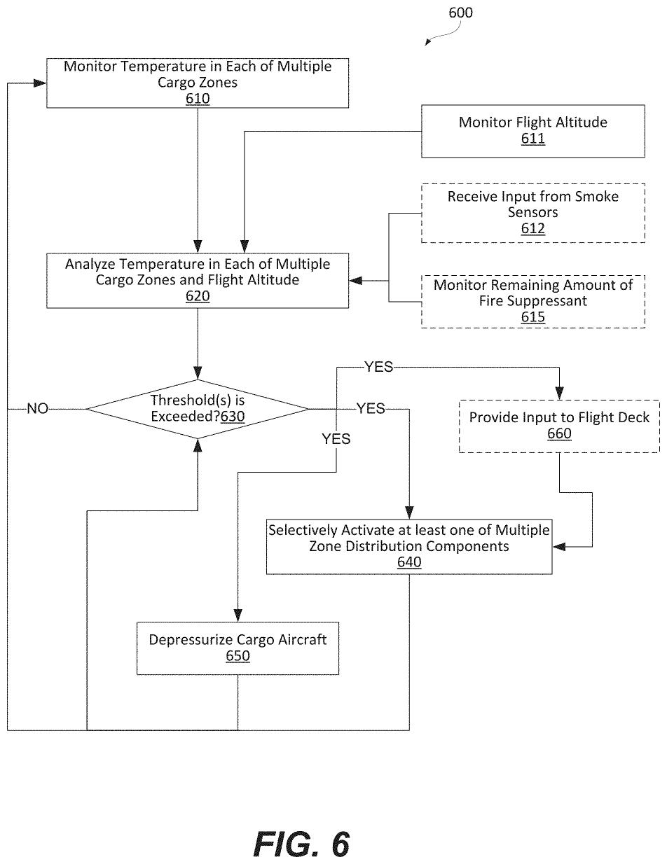

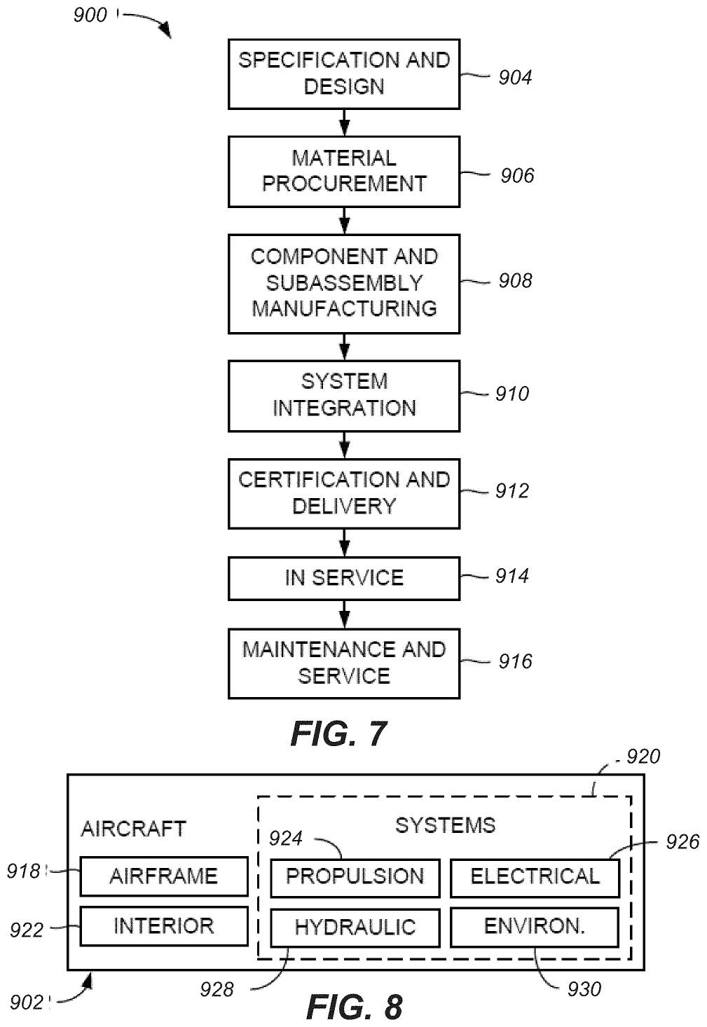

Accordingly, the apparatus and methods described above are applicable for aircraft manufacturing and service method 900 as shown in FIG. 7 and for aircraft 902 as shown in FIG. 8. During pre-production, method 900 includes specification and design 904 of aircraft 902 and material procurement 906. During production, component and subassembly manufacturing 908 and system integration 910 of aircraft 902 takes place. Thereafter, aircraft 902 goes through certification and delivery 912 in order to be placed in service 914. While in service by a customer, aircraft 902 is scheduled for routine maintenance and service 916, which also includes modification, reconfiguration, refurbishment, and so on.

In some examples, each of the processes of method 900 is performed or carried out by a system integrator, a third party, and/or an operator, e.g., a customer. For the purposes of this description, a system integrator includes without limitation any number of aircraft manufacturers and major-system subcontractors; a third party includes without limitation any number of venders, subcontractors, and suppliers; and an operator can be an airline, leasing company, military entity, service organization, and so on.

As shown in FIG. 8, aircraft 902 produced by method 900 includes airframe 918 with plurality of systems 920 and interior 922. The airframe 918 includes wings of the aircraft 902. Examples of systems 920 include one or more of propulsion system 924, electrical system 926, hydraulic system 928, and environmental system 930. Any number of other systems can be included.

Apparatus and methods presented herein can be employed during any one or more of the stages of method 900. For example, components or subassemblies corresponding to manufacturing 908 are fabricated or manufactured in a manner similar to components or subassemblies produced while aircraft 902 is in service. Also, one or more apparatus examples, method examples, or a combination thereof are utilized during manufacturing 908 and system integration 910, for example, by substantially expediting assembly of or reducing the cost of an aircraft 902. Similarly, one or more of apparatus examples, method examples, or a combination thereof are utilized while aircraft 902 is in service, for example and without limitation, to maintenance and service 916.

### Further Examples

Further, description includes examples according to following clauses:

Clause 1. A zonal fire suppression system for use in a cargo area of a cargo aircraft for hauling cargo, the zonal fire suppression system comprising:

a thermal monitoring sub-system, configured to extend across multiple cargo zones of the cargo area and to individually monitor temperature in each of the multiple cargo zones;

a fire suppressant material distribution sub-system, comprising multiple zone distribution components for positioning across the multiple cargo zones of the cargo area such that each of the multiple cargo zones corresponds to a different arrangement of the multiple zone distribution components; and

a fire suppression controller, configured to receive the temperature, measured in each of the multiple cargo zones by the thermal monitoring sub-system and a flight altitude of the cargo aircraft and to perform at least one of (a) selectively activating of at least one of the multiple zone distribution components of the fire suppressant material distribution sub-system to selectively release a fire suppressant material within one or more of the multiple cargo zones based on at least one of the temperature in each of the multiple cargo zones or the flight altitude of the cargo aircraft, or (b) depressurizing the cargo aircraft based on at least one of the temperature in each of the multiple cargo zones or the flight altitude of the cargo aircraft.

2. The zonal fire suppression system of clause 1, wherein the fire suppression controller is configured to disable depressurizing the cargo aircraft when cargo in the cargo area is oxygen-dependent.

3. The zonal fire suppression system of any one of clauses 1-2, further comprising a fire suppressant material source, fluidically coupled to the fire suppressant material distribution sub-system, wherein the fire suppressant material source comprises a fire suppressant material driver which is a pressurized gas or a pump.

4. The zonal fire suppression system of clause 3, wherein the fire suppression controller is configured to activate the fire suppressant material driver in sync with activating at least one of the multiple zone distribution components of the fire suppressant material distribution sub-system.

5. The zonal fire suppression system of clause 1, wherein:

each of the multiple zone distribution components comprises a valve, a zone conduit, and one or more distributors;

the valve is coupled to and selectively controls flow of the fire suppressant material to the zone conduit configured to extend within a corresponding one of the multiple cargo zones; and

the one or more distributors are fluidically coupled to the zone conduit.

6. The zonal fire suppression system of clause 5, wherein the valve of each of the multiple zone distribution components is independently controlled by the fire suppression controller.

7. The zonal fire suppression system of any one of clauses 5-6, wherein the one or more distributors are configured to release the fire suppressant material in a form of a mist.

8. The zonal fire suppression system of any one of clauses 5-7, wherein the zone conduit of one of the multiple zone distribution components is configured to overlap with the zone conduit of an adjacent one of the multiple zone distribution components.

9. The zonal fire suppression system of clause 8, wherein an overlap between the zone conduit of the one of the multiple zone distribution components and the zone conduit of the adjacent one of the multiple zone distribution components is between about 20% and about 80% based on a size of each of the multiple zone distribution components.

10. The zonal fire suppression system of clause 8, wherein an overlap between the zone conduit of the one of the multiple zone distribution components and the zone conduit of the adjacent one of the multiple zone distribution components is between about 40% and about 50% based on a size of each of the multiple zone distribution components.

11. The zonal fire suppression system of any one of clauses 1-10, further comprising a fire suppression material contained in a fire suppression source, and wherein the fire suppressant material is liquid based.

12. The zonal fire suppression system of clause 11, wherein the fire suppressant material comprises at least one fire suppressant material selected from the group consisting of water, foam, and mixtures thereof.

13. The zonal fire suppression system of clause 1, wherein:

the fire suppression controller is configured to selectively activate at least three adjacent of the multiple zone distribution components of the fire suppressant material distribution sub-system based on the temperature in one of the multiple cargo zones; and

one of the multiple cargo zones corresponds to a middle one of the three adjacent of the multiple zone distribution components.

14. The zonal fire suppression system of any one of clauses 1-13, wherein the fire suppression controller is further configured to selectively activate at least one of the multiple zone distribution components of the fire suppressant material distribution sub-system based on at least one of a phase of flight, an altitude of the cargo aircraft, pressure inside the cargo area, amount of the fire suppressant material available on the cargo aircraft, temperature in a cargo zone as sensed by the thermal monitoring sub-system, or combinations thereof.

15. The zonal fire suppression system of any one of clauses 1-14, wherein the fire suppression controller is further configured to communicate with a flight deck of the cargo aircraft.

16. The zonal fire suppression system of clause 15, wherein the fire suppression controller is further configured to selectively activate at least one of the multiple zone distribution components of the fire suppressant material distribution sub-system based on input from the flight deck.

17. The zonal fire suppression system of any one of clauses 1-16, wherein the fire suppression controller is further configured to receive input from each of multiple smoke detectors, positioned in the multiple cargo zones, and to selectively activate at least one of the multiple zone distribution components of the fire suppressant material distribution sub-system based on the input from each of the multiple smoke detectors.

18. The zonal fire suppression system of any one of clauses 1-17, wherein the fire suppression controller is configured to selectively activate at least one of the multiple zone distribution components of the fire suppressant material distribution sub-system based on at least one of the temperature in each of the multiple cargo zones exceeding a maximum temperature threshold or an increase in the temperature in each of the multiple cargo zones exceeding a maximum rate threshold.

19. The zonal fire suppression system any one of clauses 1-18, wherein the thermal monitoring sub-system is a continuous fiber-optic temperature sensor.

20. The zonal fire suppression system of any one of clauses 1-19, wherein when the thermal monitoring sub-system detects a temperature above 100° C. and the cargo aircraft is at the flight altitude above 6,000 meters, the fire suppression controller is configured to: (a) selectively activate at least one of the multiple zone distribution components of the fire suppressant material distribution sub-system, and (b) to depressurizes the cargo aircraft.

21. The zonal fire suppression system of any one of clauses 1-20, wherein when the thermal monitoring sub-system depicts a temperature above 100° C. and the cargo aircraft is at an altitude below 6000 meters, the fire suppression controller is configured to selectively activate at least one of the multiple zone distribution components of the fire suppressant material distribution sub-system without depressurizing the cargo aircraft.

22. A method for suppressing fire in a cargo area of a cargo aircraft using a zonal fire suppression system, the method comprising:

monitoring temperature in each of multiple cargo zones of the cargo area using a thermal monitoring sub-system of the zonal fire suppression system;

analyzing the temperature in each of the multiple cargo zones using fire suppression controller of the zonal fire suppression system;

monitoring a flight altitude of the cargo aircraft; and

based on the temperature in at least one of the multiple cargo zones and the flight altitude of the cargo aircraft, performing at least one of (a) selectively activating of at least one of multiple zone distribution components of a fire suppressant material distribution sub-system to selectively release a fire suppressant material within one or more of the multiple cargo zones based on at least one of the temperature in each of the multiple cargo zones or the flight altitude of the cargo aircraft or (b) depressurizing the cargo aircraft based on at least one of the temperature in each of the multiple cargo zones or the flight altitude of the cargo aircraft.

23. The method of clause 22, wherein analyzing the temperature in each of the multiple cargo zones comprises at least one of comparing the temperature in each of the multiple cargo zones to a maximum temperature threshold or comparing an increase in the temperature in each of the multiple cargo zones to a maximum rate threshold.

24. The method of clause 23, further comprising, if the temperature in at least one of the multiple cargo zones exceeds one or more temperature-related thresholds, depressurizing the cargo area.

25. The method of clause 24, wherein the cargo aircraft is depressurized prior to activating at least one of multiple zone distribution components.

26. The method of any one of clauses 22-25, further comprising monitoring an amount of a fire suppressant material in a fire suppressant material source of the zonal fire suppression system.

27. The method of clause 26, wherein selectively activating of at least one of multiple zone distribution components is further based on the amount of the fire suppressant material in the fire suppressant material source.

28. The method of any one of clauses 22-27, wherein selectively activating at least one of multiple zone distribution components comprises activating only one of the multiple zone distribution components, extending over the at least one of the multiple cargo zones and both adjacent ones of the multiple cargo zones.

29. The method of any one of clauses 22-28, wherein selectively activating at least one of multiple zone distribution components comprises activating three of the multiple zone distribution components, extending over the at least one of the multiple cargo zones and both adjacent ones of the multiple cargo zones.

30. The method of any one of clauses 22-29, wherein selectively activating at least one of multiple zone distribution components comprises generating fire suppressant material mist in the at least one of the multiple cargo zones.

31. The method of any one of clauses 22-30, wherein selectively activating at least one of multiple zone distribution components is further based on at least one of a phase of flight, pressure inside the cargo area, amount of the fire suppressant material available on the cargo aircraft, or temperature in a cargo zone as sensed by the thermal monitoring sub-system.

32. The method of any one of clauses 22-31, further comprising providing input from the thermal monitoring sub-system to a flight deck of the cargo aircraft.

33. The method of clause 32, wherein the fire suppressant material distribution sub-system of the zonal fire suppression system is controllable from the flight deck of the cargo aircraft.

34. The method of any one of clauses 22-33, further comprising receiving input from each of multiple smoke detectors, positioned in the multiple cargo zones, wherein activating at least one of multiple zone distribution components is further based on the input from each of multiple smoke detectors.

35. The method of any one of clauses 22-34, wherein monitoring temperature in each of multiple cargo zones is performed continuously.

36. A zonal fire suppression system for use in a cargo area of a cargo aircraft for hauling cargo, the zonal fire suppression system comprising:

a thermal monitoring sub-system, configured to extend across multiple cargo zones of the cargo area and to individually monitor temperature in each of the multiple cargo zones;

a fire suppressant material distribution sub-system, comprising multiple zone distribution components for positioning across the multiple cargo zones of the cargo area such that each of the multiple cargo zones corresponds to a different arrangement of the multiple zone distribution components, wherein:
each of the multiple zone distribution components comprises a zone conduit and one or more distributors,
the one or more distributors are fluidically coupled to the zone conduit, and
the zone conduit of one of the multiple zone distribution components is configured to overlap with the zone conduit of an adjacent one of the multiple zone distribution components; and

a fire suppression controller, configured to receive the temperature, measured in each of the multiple cargo zones by the thermal monitoring sub-system and, optionally, a flight altitude of the cargo aircraft and to perform at least one of (a) selectively activating of at least one of the multiple zone distribution components of the fire suppressant material distribution sub-system to selectively release a fire suppressant material within one or more of the multiple cargo zones based on at least one of the temperature in each of the multiple cargo zones or the flight altitude of the cargo aircraft or (b) depressurizing the cargo aircraft based on at least one of the temperature in each of the multiple cargo zones or the flight altitude of the cargo aircraft.

37. The zonal fire suppression system of clause 36, wherein each of the multiple zone distribution components further comprises a valve, and wherein the valve is coupled to and selectively controls flow of the fire suppressant material to the zone conduit configured to extend within a corresponding one of the multiple cargo zones.

38. The zonal fire suppression system of clause 37, wherein the valve of each of the multiple zone distribution components is independently controlled by the fire suppression controller.

39. The zonal fire suppression system of any one of clauses 36-37, wherein the zone conduit of one of the multiple zone distribution components is configured to overlap with the zone conduit of an adjacent one of the multiple zone distribution components.

40. The zonal fire suppression system of clause 39, wherein an overlap between the zone conduit of the one of the multiple zone distribution components and the zone conduit of the adjacent one of the multiple zone distribution components is between about 40% and about 50% based on a size of each of the multiple zone distribution components.

41. The zonal fire suppression system of any one of clauses 36-40, further comprising a fire suppression material contained in a fire suppression source, and wherein the fire suppressant material is liquid based.

42. The zonal fire suppression system of clause 41, wherein the fire suppressant material comprises at least one fire suppressant material selected from the group consisting of water, foam, and mixtures thereof.

43. The zonal fire suppression system of any one of clauses 36-43, wherein the fire suppression controller is configured to selectively activate at least three adjacent of the multiple zone distribution components of the fire suppressant material distribution sub-system based on the temperature in one of the multiple cargo zones, and wherein one of the multiple cargo zones corresponds to a middle one of the three adjacent of the multiple zone distribution components.

44. The zonal fire suppression system of any one of clauses 36-43, wherein the fire suppression controller is further configured to selectively activate at least one of the multiple zone distribution components of the fire suppressant material distribution sub-system based on at least one of a phase of flight, an altitude of the cargo aircraft, pressure inside the cargo area, amount of the fire suppressant material available on the cargo aircraft, temperature in a cargo zone as sensed by the thermal monitoring sub-system, or combinations thereof.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatus. Accordingly, the present examples are to be considered as illustrative and not restrictive.

1. A zonal fire suppression system for use in a cargo area of a cargo aircraft for hauling cargo, the zonal fire suppression system comprising:
a thermal monitoring sub-system, configured to extend across multiple cargo zones of the cargo area and to individually monitor temperature in each of the multiple cargo zones;
a fire suppressant material distribution sub-system, comprising multiple zone distribution components for positioning across the multiple cargo zones of the cargo area such that each of the multiple cargo zones corresponds to a different arrangement of the multiple zone distribution components; and
a fire suppression controller, configured to receive the temperature, measured in each of the multiple cargo zones by the thermal monitoring sub-system and a flight altitude of the cargo aircraft and to perform at least one of
(a) selectively activating of at least one of the multiple zone distribution components of the fire suppressant material distribution sub-system to selectively release a fire suppressant material within one or more of the multiple cargo zones based on at least one of the temperature in each of the multiple cargo zones or the flight altitude of the cargo aircraft or
(b) depressurizing the cargo aircraft based on at least one of the temperature in each of the multiple cargo zones or the flight altitude of the cargo aircraft.

2. (canceled)

3. The zonal fire suppression system of claim 1, further comprising a fire suppressant material source, fluidically coupled to the fire suppressant material distribution sub-system, wherein the fire suppressant material source comprises a fire suppressant material driver which is a pressurized gas or a pump.

4. (canceled)

5. The zonal fire suppression system of claim 1, wherein:
each of the multiple zone distribution components comprises a valve, a zone conduit, and one or more distributors;
the valve is coupled to and selectively controls flow of the fire suppressant material to the zone conduit configured to extend within a corresponding one of the multiple cargo zones; and
the one or more distributors are fluidically coupled to the zone conduit.

6-7. (canceled)

8. The zonal fire suppression system of claim 5, wherein the zone conduit of one of the multiple zone distribution components is configured to overlap with the zone conduit of an adjacent one of the multiple zone distribution components.

9-10. (canceled)

11. The zonal fire suppression system of claim 1, further comprising a fire suppression material contained in a fire suppression source, and wherein the fire suppressant material is liquid based.

12. The zonal fire suppression system of claim 11, wherein the fire suppressant material comprises at least one fire suppressant material selected from the group consisting of water, foam, and mixtures thereof.

13. The zonal fire suppression system of claim 1, wherein:
the fire suppression controller is configured to selectively activate at least three adjacent of the multiple zone distribution components of the fire suppressant material distribution sub-system based on the temperature in one of the multiple cargo zones; and
one of the multiple cargo zones corresponds to a middle one of the three adjacent of the multiple zone distribution components.

14. The zonal fire suppression system of claim 1, wherein the fire suppression controller is further configured to selectively activate at least one of the multiple zone distribution components of the fire suppressant material distribution sub-system based on at least one of a phase of flight, an altitude of the cargo aircraft, pressure inside the cargo area, amount of the fire suppressant material available on the cargo aircraft, temperature in a cargo zone as sensed by the thermal monitoring sub-system, or combinations thereof.

15. The zonal fire suppression system of claim 1, wherein the fire suppression controller is further configured to communicate with a flight deck of the cargo aircraft.

16. The zonal fire suppression system of claim 15, wherein the fire suppression controller is further configured to selectively activate at least one of the multiple zone distribution components of the fire suppressant material distribution sub-system based on input from the flight deck.

17. The zonal fire suppression system of claim 1, wherein the fire suppression controller is further configured to receive input from each of multiple smoke detectors, positioned in the multiple cargo zones, and to selectively activate at least one of the multiple zone distribution components of the fire suppressant material distribution sub-system based on the input from each of the multiple smoke detectors.

18. The zonal fire suppression system of claim 1, wherein the fire suppression controller is configured to selectively activate at least one of the multiple zone distribution components of the fire suppressant material distribution sub-system based on at least one of:
the temperature in each of the multiple cargo zones exceeding a maximum temperature threshold; or
an increase in the temperature in each of the multiple cargo zones exceeding a maximum rate threshold.

19-21. (canceled)

22. A method for suppressing fire in a cargo area of a cargo aircraft using a zonal fire suppression system, the method comprising:
monitoring temperature in each of multiple cargo zones of the cargo area using a thermal monitoring sub-system of the zonal fire suppression system;
analyzing the temperature in each of the multiple cargo zones using fire suppression controller of the zonal fire suppression system;
monitoring a flight altitude of the cargo aircraft; and
based on the temperature in at least one of the multiple cargo zones and the flight altitude of the cargo aircraft, performing at least one of
(a) selectively activating of at least one of multiple zone distribution components of a fire suppressant material distribution sub-system to selectively release a fire suppressant material within one or more of the multiple cargo zones based on at least one of the temperature in each of the multiple cargo zones or the flight altitude of the cargo aircraft or
(b) depressurizing the cargo aircraft based on at least one of the temperature in each of the multiple cargo zones or the flight altitude of the cargo aircraft.

23. The method of claim 22, wherein analyzing the temperature in each of the multiple cargo zones comprises at least one of:
comparing the temperature in each of the multiple cargo zones to a maximum temperature threshold; or
comparing an increase in the temperature in each of the multiple cargo zones to a maximum rate threshold.

24. The method of claim 23, further comprising, if the temperature in at least one of the multiple cargo zones exceeds one or more temperature-related thresholds, depressurizing the cargo area.

25. The method of claim 24, wherein the cargo aircraft is depressurized prior to activating at least one of multiple zone distribution components.

26. The method of claim 22, further comprising monitoring an amount of a fire suppressant material in a fire suppressant material source of the zonal fire suppression system.

27. The method of claim 26, wherein selectively activating of at least one of multiple zone distribution components is further based on the amount of the fire suppressant material in the fire suppressant material source.

28-34. (canceled)

35. The method of claim 22, wherein monitoring temperature in each of multiple cargo zones is performed continuously.

36. A zonal fire suppression system for use in a cargo area of a cargo aircraft for hauling cargo, the zonal fire suppression system comprising:
a thermal monitoring sub-system, configured to extend across multiple cargo zones of the cargo area and to individually monitor temperature in each of the multiple cargo zones;
a fire suppressant material distribution sub-system, comprising multiple zone distribution components for positioning across the multiple cargo zones of the cargo area such that each of the multiple cargo zones corresponds to a different arrangement of the multiple zone distribution components, wherein:
each of the multiple zone distribution components comprises a zone conduit and one or more distributors,
the one or more distributors are fluidically coupled to the zone conduit, and
the zone conduit of one of the multiple zone distribution components is configured to overlap with the zone conduit of an adjacent one of the multiple zone distribution components; and
a fire suppression controller, configured to receive the temperature, measured in each of the multiple cargo zones by the thermal monitoring sub-system and, optionally, a flight altitude of the cargo aircraft and to perform at least one of
(a) selectively activating of at least one of the multiple zone distribution components of the fire suppressant material distribution sub-system to selectively release a fire suppressant material within one or more of the multiple cargo zones based on at least one of the temperature in each of the multiple cargo zones or the flight altitude of the cargo aircraft or
(b) depressurizing the cargo aircraft based on at least one of the temperature in each of the multiple cargo zones or the flight altitude of the cargo aircraft.

37-44. (canceled)
